(19) United States
(12) Patent Application Publication
(10) Pub. No.: US 2019/0325258 A1
(43) Pub. Date: Oct. 24, 2019

(54) EARLY FEEDBACK OF SCHEMATIC CORRECTNESS IN FEATURE MANAGEMENT FRAMEWORKS

(71) Applicant: Microsoft Technology Licensing, LLC, Redmond, WA (US)

(72) Inventors: David J. Stein, Mountain View, CA (US); Ke Wu, Sunnyvale, CA (US); Priyanka Gariba, San Mateo, CA (US); Grace W. Tang, Los Altos, CA (US); Yangchun Luo, Sunnyvale, CA (US); Songxiang Gu, Sunnyvale, CA (US); Bee-Chung Chen, San Jose, CA (US)

(73) Assignee: Microsoft Technology Licensing, LLC, Redmond, WA (US)

(21) Appl. No.: 15/958,997

(22) Filed: Apr. 20, 2018

(51) Int. Cl. G06K 9/62; G06F 15/18

(52) U.S. Cl. CPC G06K 9/623; G06F 15/18; G06K 9/6256; G06K 9/6231

(57) ABSTRACT

The disclosed embodiments provide a system for processing data. During operation, the system obtains feature configurations for a set of features and a command for inspecting a data set that is produced using the feature configurations. Next, the system obtains, from the feature configurations, one or more anchors containing metadata for accessing the set of features in an environment and a join configuration for joining a feature with one or more additional features. The system then uses the anchors to retrieve feature values of the features and zips the feature values according to the join configuration without matching entity keys associated with the feature values. Finally, the system outputs the zipped feature values in response to the command.

### RELATED APPLICATIONS

The subject matter of this application is related to the subject matter in a co-pending non-provisional application entitled “Common Feature Protocol for Collaborative Machine Learning,” having Ser. No. 15/046,199, and filing date 17 Feb. 2016 (Attorney Docket No. LI-901891-US-NP).

The subject matter of this application is also related to the subject matter in a co-pending non-provisional application entitled “Framework for Managing Features Across Environments,” having serial number TO BE ASSIGNED, and filing date TO BE ASSIGNED (Attorney Docket No. LI-902216-US-NP).

The subject matter of this application is also related to the subject matter in a co-pending non-provisional application filed on the same day as the instant application, entitled “Managing Derived and Multi-Entity Features Across Environments,” having serial number TO BE ASSIGNED, and filing date TO BE ASSIGNED (Attorney Docket No. LI-902217-US-NP).

### BACKGROUND

### Field

The disclosed embodiments relate to machine learning systems. More specifically, the disclosed embodiments relate to techniques for providing early feedback of schematic correctness in feature management frameworks.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of machine-learning models. The discovered information may then be used to guide decisions and/or perform actions related to the data. For example, the output of a machine-learning model may be used to guide marketing decisions, assess risk, detect fraud, predict behavior, and/or customize or optimize use of an application or website.

However, significant time, effort, and overhead may be spent on feature selection during creation and training of machine-learning models for analytics. For example, a data set for a machine-learning model may have thousands to millions of features, including features that are created from combinations of other features, while only a fraction of the features and/or combinations may be relevant and/or important to the machine-learning model. At the same time, training and/or execution of machine-learning models with large numbers of features typically require more memory, computational resources, and time than those of machine-learning models with smaller numbers of features. Excessively complex machine-learning models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams. The same features may further be identified and/or specified multiple times during different steps associated with creating, training, validating, and/or executing the same machine-learning model.

Consequently, creation and use of machine-learning models in analytics may be facilitated by mechanisms for improving the monitoring, management, sharing, propagation, and reuse of features among the machine-learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating the processing of a command in accordance with the disclosed embodiments.

FIG. 5 shows a flowchart illustrating the processing of a command in accordance with the disclosed embodiments.

FIG. 6 shows a flowchart illustrating the processing of a command in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

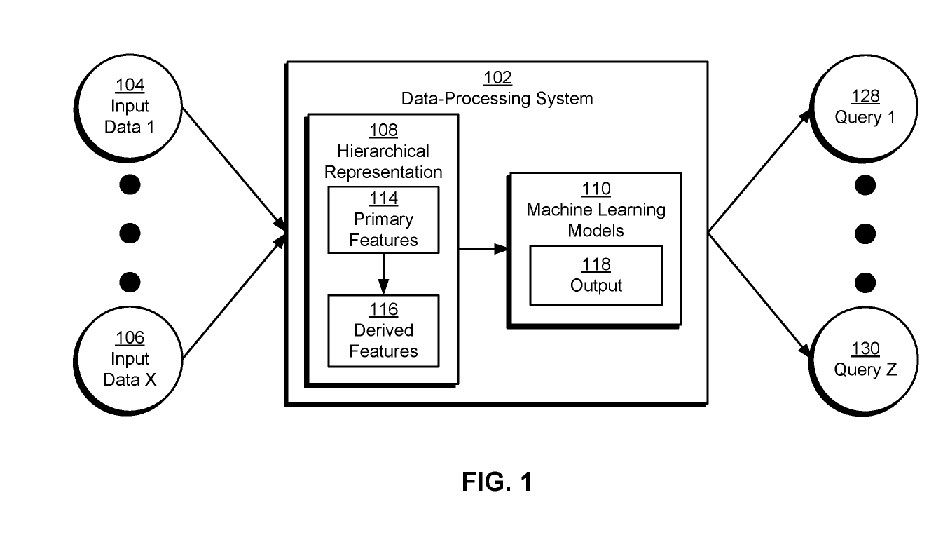

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more machine learning models 110 for analyzing input data related to users, organizations, applications, job postings, purchases, electronic devices, websites, content, sensor measurements, and/or other categories. Machine learning models 110 may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the input data; and/or guide decisions or actions related to the data. For example, data-processing system 102 may use machine learning models 110 to generate output 118 that includes scores, classifications, recommendations, estimates, predictions, and/or other properties. Output 118 may be inferred or extracted from primary features 114 in the input data and/or derived features 116 that are generated from primary features 114 and/or other derived features. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After output 118 is generated from one or more sets of primary and/or derived features, output 118 is provided in responses to queries (e.g., query 1 128, query z 130) of data-processing system 102. In turn, the queried output 118 may improve revenue, interaction with the users and/or organizations, use of the applications and/or content, and/or other metrics associated with the input data.

In one or more embodiments, data-processing system 102 uses a hierarchical representation 108 of primary features 114 and derived features 116 to organize the sharing, production, and consumption of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of machine learning models 110 or applications that accept the derived features as input.

Consequently, data-processing system 102 may implement, in hierarchical representation 108, a common feature protocol that describes a feature set in a centralized and structured manner, which in turn can be used to coordinate large-scale and/or collaborative machine learning across multiple entities and machine learning models 110. Common feature protocols for large-scale collaborative machine learning are described in a co-pending non-provisional application entitled “Common Feature Protocol for Collaborative Machine Learning,” having Ser. No. 15/046,199, and filing date 17 Feb. 2016 (Attorney Docket No. LI-901891-US-NP), which is incorporated herein by reference.

In one or more embodiments, primary features 114 and/or derived features 116 are obtained and/or used with an online professional network, social network, or other community of users that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the online professional network, the member's tenure on the online professional network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the online professional network), publishing activity (e.g., publishing posts or articles in the online professional network), mobile activity (e.g., accessing the social network through a mobile device), job search activity (e.g., job searches, page views for job listings, job applications, etc.), and/or email activity (e.g., accessing the online professional network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

Those skilled in the art will appreciate that primary features 114 and/or derived features 116 may be obtained from multiple data sources, which in turn may be distributed across different environments. For example, the features may be obtained from data sources in online, offline, nearline, streaming, and/or search-based execution environments. In addition, each data source and/or environment may have a separate application-programming interface (API) for retrieving and/or transforming the corresponding features. Consequently, managing, sharing, obtaining, and/or calculating features across the environments may require significant overhead and/or customization to specific environments and/or data sources.

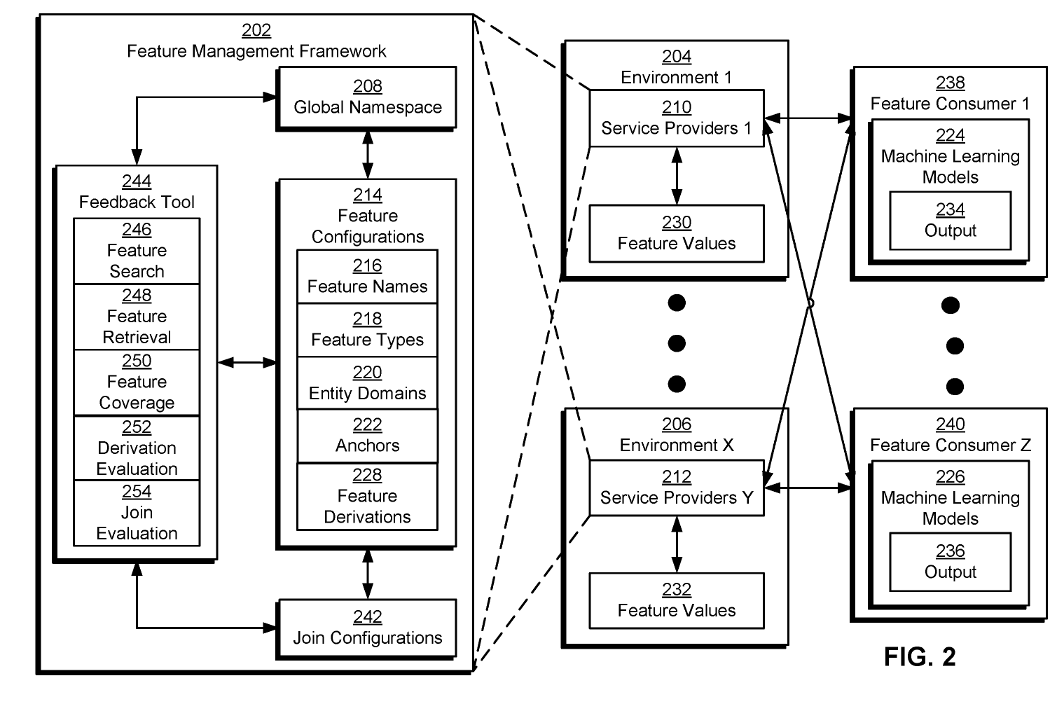

In one or more embodiments, data-processing system 102 includes functionality to perform centralized feature management in a way that is decoupled from environments, systems, and/or use cases of the features. As shown in FIG. 2, a system for processing data (e.g., data-processing system 102 of FIG. 1) includes a feature management framework 202 that executes in and/or is deployed across a number of service providers (e.g., service providers 1 210, service providers y 212) in different environments (e.g., environment 1 204, environment x 206).

The environments include different execution contexts and/or groups of hardware and/or software resources in which feature values 230-232 of the features can be obtained or calculated. For example, the environments may include an online environment that provides real-time feature values, a nearline or streaming environment that emits events containing near-realtime records of updated feature values, an offline environment that calculates feature values on a periodic and/or batch-processing basis, and/or a search-based environment that performs fast reads of databases and/or other data stores in response to queries for data in the data stores.

One or more environments may additionally be contained or nested in one or more other environments. For example, an online environment may include a “remix” environment that contains a library framework for executing one or more applications and/or generating additional features.

The service providers may include applications, processes, jobs, services, and/or modules for generating and/or retrieving feature values 230-232 for use by a number of feature consumers (e.g., feature consumer 1 238, feature consumer z 240). The feature consumers may use one or more sets of feature values 230-232 as input to one or more machine learning models 224-226 during training, testing, and/or validation of machine learning models 224-226 and/or scoring using machine learning models 224-226. In turn, output 234-236 generated by machine learning models 224-226 from the sets of feature values 230-232 may be used by the feature consumers and/or other components to adjust parameters and/or hyperparameters of machine-learning models 224-226; verify the performance of machine-learning models 224-226; select versions of machine-learning models 224-226 for use in production or real-world settings; and/or make inferences, recommendations, predictions, and/or estimates related to feature values 230-232 within the production or real-world settings.

In one or more embodiments, the service providers use components of feature management framework 202 to generate and/or retrieve feature values 230-232 of features from the environments in a way that is decoupled from the locations of the features and/or operations or computations used to generate or retrieve the corresponding feature values 230-232 within the environments. First, the service providers organize the features within a global namespace 208 that spans the environments. Global namespace 208 may include a hierarchical representation of feature names 216 and use scoping relationships in the hierarchical representation to disambiguate among features with common or similar names, as described in the above-referenced application. Consequently, global namespace 208 may replace references to locations of the features (e.g., filesystem paths, network locations, streams, tables, fields, services, etc.) with higher-level abstractions for identifying and accessing the features.

Second, the service providers use feature configurations 214 in feature management framework 202 to define, identify, locate, retrieve, and/or calculate features from the respective environments. Each feature configuration includes metadata and/or information related to one or more features in global namespace 208. Individual feature configurations 214 can be independently created and/or updated by a user, team, and/or entity without requiring knowledge of feature configurations 214 for other features and/or from other users, teams, and/or entities.

Feature configurations 214 include feature names 216, feature types 218, entity domains 220, anchors 222, feature derivations 228, and join configurations 242 associated with the features. Feature names 216 include globally scoped identifiers for the features, as obtained from and/or maintained using global namespace 208. For example, a feature representing the title in a member's profile with a social network or online professional network may have a globally namespaced feature name of “org.member.profile.title.” The feature name may allow the feature to be distinguished from a different feature for a title in a job listing, which may have a globally namespaced feature name of “org.job.title.”

Feature types 218 include semantic types that describe how the features can be used with machine learning models 224-226. For example, each feature may be assigned a feature type that is numeric, binary, categorical, categorical set, categorical bag, and/or vector. The numeric type represents numeric values such as real numbers, integers, and/or natural numbers. The numeric type may be used with features such as numeric identifiers, metrics (e.g., page views, messages, login attempts, user sessions, click-through rates, conversion rates, spending amounts, etc.), statistics (e.g., mean, median, maximum, minimum, mode, percentile, etc.), scores (e.g., connection scores, reputation scores, propensity scores, etc.), and/or other types of numeric data or measurements.

The binary feature type includes Boolean values of 1 and 0 that indicate if a corresponding attribute is true or false. For example, binary features may specify a state of a member (e.g., active or inactive) and/or whether a condition has or has not been met.

Categorical, categorical set, and categorical bag feature types include fixed and/or limited names, labels, and/or other qualitative attributes. For example, a categorical feature may represent a single instance of a color (e.g., red, blue, yellow, green, etc.), a type of fruit (e.g., orange, apple, banana, etc.), a blood type (e.g., A, B, AB, O, etc.), and/or a breed of dog (e.g., collie, shepherd, terrier, etc.). A categorical set may include one or more unique values of a given categorical feature, such as {apple, banana, orange} for the types of fruit found in a given collection. A categorical bag may include counts of the values, such as {banana: 2, orange: 3} for a collection of five pieces of fruit and/or a bag of words from a sentence or text document.

The vector feature type represents an array of features, with each dimension or element of the array corresponding to a different feature. For example, a feature vector may include an array of metrics and/or scores for characterizing a member of a social network. In turn, a metric such as Euclidean distance or cosine similarity may be calculated from feature vectors of two members to measure the similarity, affinity, and/or compatibility of the members.

Entity domains 220 identify classes of entities described by the features. For example, entity domains 220 for features related to a social network or online professional network may include members, jobs, groups, companies, products, business units, advertising campaigns, and/or experiments. Entity domains 220 may be encoded and/or identified within global namespace 208 (e.g., “jobs.title” versus “member.title” for features related to professional titles) and/or specified separately from global namespace 208 (e.g., “feature1.entitydomain=members”). One or more features may additionally have compound entity domains 220. For example, an interaction feature between members and jobs may have an entity domain of {members, jobs}.

Anchors 222 include metadata that describes how to access the features in specific environments. For example, anchors 222 may include locations or paths of the features in the environments; classes, functions, methods, calls, and/or other mechanisms for accessing data related to the features; and/or formulas or operations for calculating and/or generating the features from the data.

A service provider may use an anchor for accessing a feature in the service provider's environment to retrieve and/or calculate one or more feature values (e.g., feature values 230-232) for the feature and provide the feature values to a feature consumer. For example, the service provider may receive, from a feature consumer, a request for obtaining feature values of one or more features from the service provider's environment. The service provider may match feature names in the request to one or more anchors 222 for the corresponding features and use the anchors and one or more entity keys (e.g., member keys, job keys, company keys, etc.) in the request to obtain feature values for the corresponding entities from the environment. The service provider may optionally format the feature values according to parameters in the request and return the feature values to the feature consumer for use in training, testing, validating, and/or executing machine learning models (e.g., machine learning models 224-226) associated with the feature consumer.

Join configurations 242 include metadata that is used to join feature values for one or more features with observation data associated with the feature values. Each join configuration may identify the features and observation data and include one or more join keys that are used by the service provider to perform join operations. In turn, a service provider may use a join configuration to generate data that is used in training, testing, and/or validation of a machine learning model. Using anchors and join configurations to access features in various environments is described in a co-pending non-provisional application filed on the same day as the instant application, entitled “Framework for Managing Features Across Environments,” having serial number TO BE ASSIGNED, and filing date TO BE ASSIGNED (Attorney Docket No. LI-902216-US-NP), which is incorporated herein by reference.

Feature derivations 228 include metadata for calculating or generating derived features (e.g., derived features 116 of FIG. 1) from other “input” features, such as primary features with anchors 222 in the respective environments and/or other derived features. For example, feature derivations 228 may include expressions, operations, and/or references to code for generating or calculating the derived features from other features. Like anchors 222, feature derivations 228 may identify features by globally namespaced feature names 216 and/or be associated with specific environments. For example, a feature derivation may specify one or more input features used to calculate a derived feature and/or one or more environments in which the input features can be accessed.

In turn, a service provider uses feature derivations 228 to verify the reachability of a derived feature in the service provider's environment, generate a dependency graph of features used to produce the derived feature, verify a compatibility of the derived feature with input features used to generate the derived feature, and obtain and/or calculate features in the dependency graph according to the determined evaluation order. Using feature derivations to generate derived features across environments is described in a co-pending non-provisional application filed on the same day as the instant application, entitled “Managing Derived and Multi-Entity Features Across Environments,” having serial number TO BE ASSIGNED, and filing date TO BE ASSIGNED (Attorney Docket No. LI-902217-US-NP), which is incorporated herein by reference.

In one or more embodiments, feature management framework 202 and/or individual service providers that implement feature management framework 202 include functionality to provide a feedback tool 244 for evaluating aspects of global namespace 208, feature configurations 214, join configurations 242, and/or other components of feature management framework 202. Feedback tool 244 includes a user interface (e.g., graphical user interface (GUI), command line interface (CLI), web-based user interface, voice-user interface, etc.) that accepts commands from users and/or otherwise interacts with the users. After a command is received from a user, feedback tool 244 uses global namespace 208, feature configurations 214, and/or join configurations 242 loaded in feature management framework 202 and/or provided by the user to process the command Feedback tool 244 then outputs data and/or values requested in the command in a response to the command.

Consequently, feedback tool 244 may be used by the users to test new feature configurations 214 and/or verify the schematic correctness of feature sets managed by the service providers based on global namespace 208, feature configurations 214, anchors 222, feature derivations 228, join configurations 242, and/or other components involved in generating and managing the feature sets. For example, the users may interact with feedback tool 244 to retrieve records containing feature names and/or feature values and verify that the retrieved records conform to schemas for the corresponding data sets. Moreover, feedback tool 244 may evaluate the commands in a way that prioritizes efficient processing and verification of schematic correctness over data accuracy, as discussed in further detail below.

As shown in FIG. 2, feedback tool 244 includes functionality to execute commands related to feature search 246, feature retrieval 248, feature coverage 250, derivation evaluation 252, and join evaluation 254. First, feedback tool 244 supports one or more commands for performing feature search 246 using global namespace 208. For example, feedback tool 244 may include a “listFeatures” command for retrieving feature names in global namespace 208. When the command is invoked without any parameters, feedback tool 244 may output a list of all feature names in global namespace 208 and/or a user-provided override to global namespace 208 (e.g., a user-specified path to a configuration file containing a custom namespace of feature names). When the command is invoked with a regular expression, string, or substring, feedback tool 244 may identify a set of feature names that match the regular expression, string, or substring and output the feature names in response to the command.

Second, feedback tool 244 supports one or more commands for performing feature retrieval 248 using global namespace 208 and/or feature configurations 214. For example, feedback tool 244 may be invoked using a command that includes parameters representing a number of records to retrieve and/or feature names of one or more features to be included in the records. In turn, feedback tool 244 may use global namespace 208 and/or feature configurations 214 to retrieve the requested number of records and output the records in response to the command.

An example command for performing feature retrieval 248 using feedback tool 244 may be invoked using the following:

dumpFeatures(3, “member_currentCompany”, “member_firstName”)

The above command has a name of “dumpFeatures” and three parameters. The first parameter specifies a number of records to retrieve (i.e., 3) using the command, the second parameter specifies a feature name for a first feature (i.e., “member_currentCompany”), and the third parameter specifies a feature name for a second feature (i.e., “member_firstName”).

Feedback tool 244 may process the example command above by retrieving the requested number of records containing feature values for the corresponding feature names Feedback tool 244 may then return and/or output the following data in response to the command:

(List(<memberId>),Map(member_firstName −> (robert −> 1.0)))
(List(<memberId>),Map(member_currentCompany −> (11670 −> 1.0),

member_firstName −> (tetsu −> 1.0)))

(List(<memberId>),Map(member_currentCompany −> (5390798 −>
1.0),

member_firstName −> (dan −> 1.0)))

Each line of the outputted data represents a record requested by the command. The first field in the line includes a set of entity keys defined in an anchor for the corresponding feature or features, such as “List(<memberId>).” The first field is followed by one or more additional fields, each containing a map of a feature name to a “term vector” containing one or more terms related to the corresponding feature. For example, the second record may include one map of the “member_currentCompany” feature name to a term vector that includes a feature value for the feature (i.e., a company identifier of 11670) and a numeric value associated with the feature (i.e., a value of 1.0 indicating that the feature value represents the member's current company). The second record also includes another map of the “member_firstName” feature to a term vector containing a feature value for the feature (i.e., a first name of “tetsu”) and a numeric value associated with the feature (i.e., a value of 1.0 indicating that the feature value represents the member's current first name).

To expedite evaluation of the command, feedback tool 244 may “zip” feature values for the first 10 records retrieved from two separate feature sets represented by the feature names of “member_currentCompany” and “member_firstName” instead of performing an expensive outer join operation that matches entity keys for the feature values before including the feature values in the outputted records. As a result, feedback tool 244 may output and/or return data that allows a user to quickly verify the formatting and/or schematic correctness of the data in lieu of “real-world” data that is produced using computationally expensive operations.

In another example, feedback tool 244 may support a command for evaluating an anchor for accessing one or more features in an environment. To process the command, feedback tool 244 may use one or more attributes of the anchor to retrieve feature values of the feature(s) from the environment and output the feature values in response to the command.

An example command for evaluating an anchor for accessing features in an environment may include the following representation:

evalAnchor(10, “““

source: “/databases/CareersDB/MemberPreference/#LATEST”
extractor: “org.anchor.PreferencesFeatures”
features: [

companySize,
preference_seniority,
preference_industry,
preference_industryCategory,
preference_location

]

”””)

The command has a name of “evalAnchor” followed by two parameters. The first parameter may specify the number of records to be retrieved (i.e., 10), and the second parameter may contain a description of an anchor for retrieving feature values for inclusion in the records. More specifically, the second parameter includes a “source” of the feature values (i.e., “/databases/CareersDB/MemberPreference/#LATEST”) and an “extractor” (“org.anchor.PreferencesFeatures”) representing a class, method, function, and/or other mechanism for obtaining the features from the source. The second parameter also includes a set of feature names of the features (“companySize”, “preference_seniority”, “preference_industry”, “preference_industryCategory”, “preference_location”).

Feedback tool 244 may process the example command above by using the extractor to obtain 10 sets of feature values for the “companySize”, “preference_seniority”, “preference_industry”, “preference_industryCategory”, and “preference_location” feature names from the source. Feedback tool 244 may then return and/or output the feature values in a format that is similar to feature values outputted using the example “dumpFeatures” command above.

Another example command for evaluating an anchor for accessing features in an environment may include the following representation:

evalAnchorExtractor(2,

“/data/derived/standardization/members_std_data/#LATEST”,
“geoStdData.countryCode”)

The command above includes a name of “evalAnchorExtractor” and three parameters. The first parameter may specify the number of records to be retrieved (i.e., 2), the second parameter may specify a source of the features (“/data/derived/standardization/members_std_data/#LATEST”), and the third parameter may include an expression for extracting a feature from the source (“geoStdData.countryCode”).

Feedback tool 244 may process the example command above by using an anchor containing the source and/or the “geoStdData.countryCode” expression to obtain feature values of the corresponding feature. Feedback tool 244 may then output the following data in response to the command:

{

debugInfo: {

geoStdData = (Record) {“countryCode”: “us”, “geoPostalCode”:
“94039”,
“geoPlaceCode”: “7-1-0-43-12”, “regionCode”: 84, “latitude”:
37.39,
“longitude”: −122.08, “standardizerVersion”: null}

geoStdData.countryCode = (String) us

}
featureValue: Map(us −> 1.0)

}
{

debugInfo: {

geoStdData = (Record) {“countryCode”: “us”, “geoPostalCode”:
“94125”,
“geoPlaceCode”: “7-1-0-38-1”, “regionCode”: 84, “latitude”:
37.78,
“longitude”: −122.42, “standardizerVersion”: null}

geoStdData.countryCode = (String) us

}
featureValue: Map(us −> 1.0)

}

The outputted data includes two records enclosed in brackets. Each record includes a “featureValue” for the “geoStdData.countryCode” feature, which is represented using a term vector containing a string (e.g., “us”) and a numeric value associated with the string (e.g., 1.0). Each record also includes a “debugInfo” field containing additional values used by the expression to generate the “featureValue.” The additional values may allow a user to determine if the feature values are generated correctly using the expression and/or debug any errors in generating the feature values.

Third, feedback tool 244 supports one or more commands for analyzing a feature coverage 250 of one or more features. For example, feedback tool 244 may obtain a command containing a parameter for a feature name and another optional parameter specifying one or more key tags (e.g., member key, job key, company key, etc.) associated with the feature name. Feedback tool 244 may use one or more anchors 222 to retrieve all feature values of the feature and all entity keys associated with the key tag(s) from an environment and calculate the coverage as the percentage of entity keys for a given key tag with feature values for the feature. If no entity keys are specified in the command, feedback tool 244 may calculate the coverage for all key tags associated with the feature. Feedback tool 244 may then output the calculated coverage in response to the command.

Fourth, feedback tool 244 supports one or more commands for performing a derivation evaluation 252 using feature derivations 228. For example, feedback tool 244 may be invoked with a command containing a parameter that specifies a feature derivation for a feature and another parameter representing the number of records to be generated using the feature derivation. As with commands for performing feature retrieval 248, the command may include the content of the feature derivation and/or identify the feature derivation by name and/or path. Feedback tool 244 may use the feature derivation to generate feature values of the derived feature from input feature values of one or more input features identified in the feature derivation. Feedback tool 244 may then output the derived feature values in response to the additional command (e.g., in a format that is similar to data that is outputted by feedback tool 244 in response to commands for feature retrieval 248). Feedback tool 244 may optionally output the input feature values with the derived feature values to allow a user to verify that the derived feature values are generated correctly.

Finally, feedback tool 244 supports one or more commands for performing a join evaluation 254 using join configurations 242. For example, feedback tool 244 may be invoked using a command containing a parameter that specifies a join configuration for a feature and another parameter representing the number of records to be generated using the join configuration. Like commands for performing feature retrieval 248 and/or derivation evaluation 252, the command may include the content of the join configuration and/or identify the join configuration by name and/or path. Feedback tool 244 may use the join configuration to generate records containing feature values and/or observation data associated with the corresponding feature names and/or labels in the join configuration. Feedback tool 244 may then output the records in response to the command.

As mentioned above, feedback tool 244 may omit expensive join operations during processing of commands for retrieving, generating, and/or joining feature values and/or observation data. As a result, feedback tool 244 may perform join evaluation 254 by zipping feature values according to the join configuration without matching entity keys associated with the feature values.

An example command for performing join evaluation 254 may include the following representation:

fakeFeatureJoin(3, “/jobs/observations_sample”, “features:[{key:

targetId, featureList: [job_location]}]”)

The command includes a name of “fakeFeatureJoin” and three parameters. The first parameter specifies a number of records to be generated (3), the second parameter includes a path of observation data to be joined with the feature values (“/jobs/observations_sample”), and the third parameter includes a join configuration that includes a join “key” of “targetId” and a “featureList” identified by “job_location.”

Feedback tool 244 may process the example command above by retrieving the observation data from the path, using feature configurations 214 to generate or retrieve feature values of the “job_location” feature from an environment, and “zipping” the feature values with the observation data without using the join key to match the feature values to the observation data. In this context, a zipping operation combines multiple lists, data sets, columns, or fields into a single data set with multiple rows, columns, or fields without matching keys associated with values in the lists, data sets, columns, or fields. Feedback tool 244 may then output the following data in response to the command:

{“label”: 0, “sourceId”: <sourceId>, “tag”: “SKIP”, “targetId”: <targetId>,
“timestamp”: 1493588110979, “weight”: 1.0, “features”: [ ]}
{“label”: 0, “sourceId”: <sourceId>, “tag”: “SKIP”, “targetId”: <targetId>,
“timestamp”: 1493588110979, “weight”: 1.0, “features”: [ ]}
{“label”: 0, “sourceId”: <sourceId>, “tag”: “SKIP”, “targetId”: <targetId>,
“timestamp”: 1493588110979, “weight”: 1.0, “features”: [

{“name”: “job_location”, “term”: “geo_latitude=−019.74”, “value”: 1.0},
{“name”: “job_location”, “term”: “geo_place=21-1406”, “value”: 1.0},
{“name”: “job_location”, “term”: “geo_longitude=−047.94”, “value”: 1.0},
{“name”: “job_location”, “term”: “geo_country=br”, “value”: 1.0},
{“name”: “job_location”, “term”: “geo_region=br:6232”, “value”: 1.0},
{“name”: “job_location”, “term”: “geo_postal=38066”, “value”: 1.0},
{“name”: “job_location”, “term”: “geo_state=MG”, “value”: 1.0},
{“name”: “job_location”, “term”: “geo_coord_y=−0.6988”, “value”: 1.0},
{“name”: “job_location”, “term”: “geo_coord_x=0.6304”, “value”: 1.0},
{“name”: “job_location”, “term”: “geo_coord_z=−0.3371”, “value”: 1.0}

]}

The outputted data includes three records containing a set of fields. The first six fields in each record include observation data from the path, and the last field includes a set of “features” containing feature values for the “job_location” feature list. The first two records lack feature values for the feature list, while the third record is populated with feature values for the feature list. To reduce computational overhead associated with joining two sets of data, the records may contain feature values that are zipped with the observation data without matching entity keys for the feature values to the observation data.

When a join configuration, feature derivation, and/or feature configuration specifies the creation of a record using two variants of the same feature, feedback tool 244 may generate the record by using, as feature values for the two variants, different subsets of feature values for the feature. As a result, the generated record may contain data that is more realistic than if feedback tool 244 simply replicated the same feature values across the variants to produce the record.

For example, a feature derivation may specify the generation of a derived feature as the difference between the values of a “numberConnections” feature for two different members of a social network. If feedback tool 244 generates 10 records containing the derived feature by obtaining the first 10 values of the feature and using the same 10 values for both members to calculate the derived feature, all 10 records may contain a value of 0 for the derived feature, which is unlikely to be representative of real-world values for the derived feature. Instead, feedback tool 244 may obtain one set of 10 values for the feature to represent one member and a different set of 10 values for the feature to represent the other member and calculate the derived feature using the two sets of values.

Feedback tool 244 may similarly support time-based retrieval, calculation, and/or “joining” of feature values in response to the corresponding commands. For example, feedback tool 244 may obtain, from a parameter in a command, a time range associated with feature values of a feature, which may include a variant of a feature that is associated with a particular entity key or key tag. The time range may be specified as a date, date range, offset, and/or another representation of an interval of time. In turn, feedback tool 244 may retrieve feature values of the feature that fall within the time range and include the feature values in records requested by the command, calculate derived feature values using the feature values, and/or zip the feature values with other feature values that are obtained from the same time range or a different time range.

By using service providers in different environments to implement, provide, and/or use a uniform feature management framework 202 containing global namespace 208, feature configurations 214, anchors 222, feature derivations 228, join configurations 242, and feedback tool 244, the system of FIG. 2 may reduce complexity and/or overhead associated with generating, managing, and/or retrieving features. In particular, feedback tool 244 may allow users to quickly and efficiently test new and/or modified feature configurations 214, anchors 222, feature derivations 228, and/or join configurations 242 and verify the schematic correctness of data sets generated using feature configurations 214, anchors 222, feature derivations 228, and/or join configurations 242. Consequently, the system may provide technological improvements related to the development and use of computer systems, applications, services, and/or workflows for producing features, consuming features, and/or using features with machine learning models.

Those skilled in the art will appreciate that the system of FIG. 2 may be implemented in a variety of ways. First, feature management framework 202, the service providers, and/or the environments may be provided by a single physical machine, multiple computer systems, one or more virtual machines, a grid, one or more databases, one or more filesystems, and/or a cloud computing system. Moreover, various components of the system may be configured to execute in an offline, online, and/or nearline basis to perform different types of processing related to managing, accessing, and using features, feature values, and machine learning models 224-226.

Second, feature configurations 214, feature values, and/or other data used by the system may be stored, defined, and/or transmitted using a number of techniques. For example, the system may be configured to accept features from different types of repositories, including relational databases, graph databases, data warehouses, filesystems, streams, online data stores, and/or flat files. The system may also obtain and/or transmit feature configurations 214, feature values, and/or other data used by or with feature management framework 202 in a number of formats, including database records, property lists, Extensible Markup language (XML) documents, JavaScript Object Notation (JSON) objects, and/or other types of structured data. Each feature configuration may further encompass one or more features, anchors 222, service providers, and/or environments.

In another example, global namespace 208 and/or feature configurations 214 may be stored at individual service providers, in a centralized repository that is synchronized with and/or replicated to the service providers, and/or in a distributed ledger or store that is maintained and/or accessed by the service providers. Each service provider may further include or have access to all feature configurations 214 for all features across all environments, or each service provider may include or have access to a subset of feature configurations 214, such as feature configurations 214 for features that are retrieved or calculated by that service provider.

Third, one or more components of the system may be combined with external tools and/or services to extend the functionality of the system. For example, feedback tool 244 may be combined with and/or include a notebook interface that allows commands supported by feedback tool 244 to be used and/or supplemented with code blocks, configurations, documentation, visualizations, equations, figures, and/or other analysis descriptions and results supported by the notebook interface.

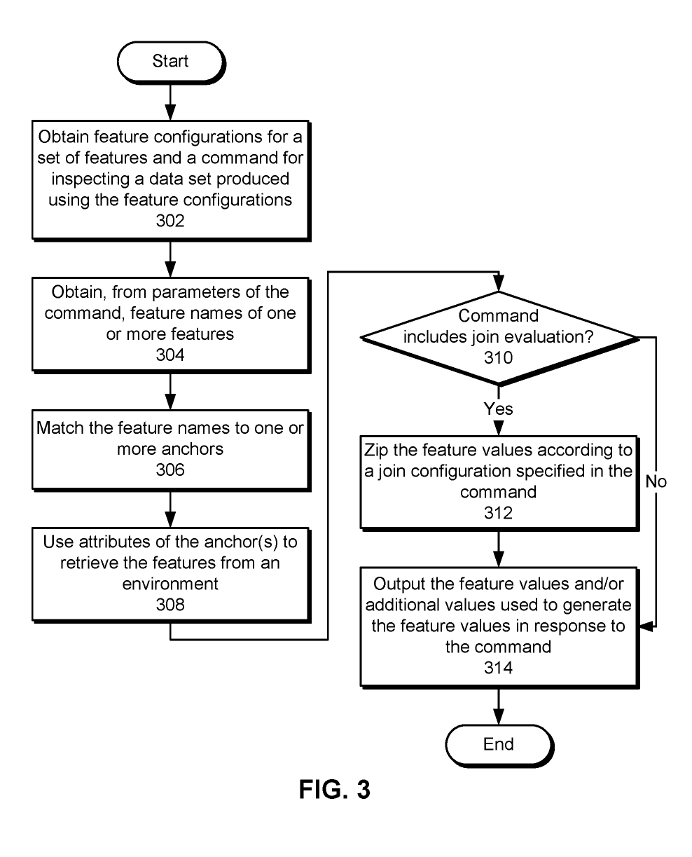

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, feature configurations for a set of features and a command for inspecting a data set produced using the feature configurations are obtained (operation 302). The feature configurations may be loaded in a service provider and/or provided by a user. Next, feature names of one or more features are obtained from parameters of the command (operation 304). For example, each feature name may be specified in a separate parameter of the command, or a list of feature names may be obtained from a file that is identified using one parameter of the command.

The feature names are matched to one or more anchors (operation 306), and attributes of the anchor(s) are used to retrieve the features from an environment (operation 308). For example, the anchor(s) may include expressions, classes, methods, functions, and/or other mechanisms for retrieving the features from an online, offline, nearline, stream-processing, and/or search-based environment. In another example, a time range associated with feature values of one or more features may be obtained from a parameter of the command, and the anchor may be used to retrieve feature values that fall within the time range for the features.

The command may also include a join evaluation (operation 310) that involves performing a “join” operation using the features. For example, the join evaluation may be indicated using the command's name and/or one or more parameters of the command. When the command includes a join evaluation, the feature values are zipped according to a join configuration specified in the command (operation 312) without matching entity keys associated with the feature values. For example, the first 10 feature values retrieved for all features identified in the join configuration may be zipped without joining the feature values by one or more entity keys. In another example, two variants of a single feature may be identified in the join configuration, and different subsets of the feature values for the single feature may be included in the zipped feature values for the two variants.

Finally, the feature values and/or additional values used to generate the feature values are outputted in response to the command (operation 314). For example, individual and/or zipped feature values may be outputted in one or more records. The records may optionally include intermediate values and/or data used to produce and/or retrieve the feature values to facilitate identification and/or debugging of errors related to generating or obtaining the feature values.

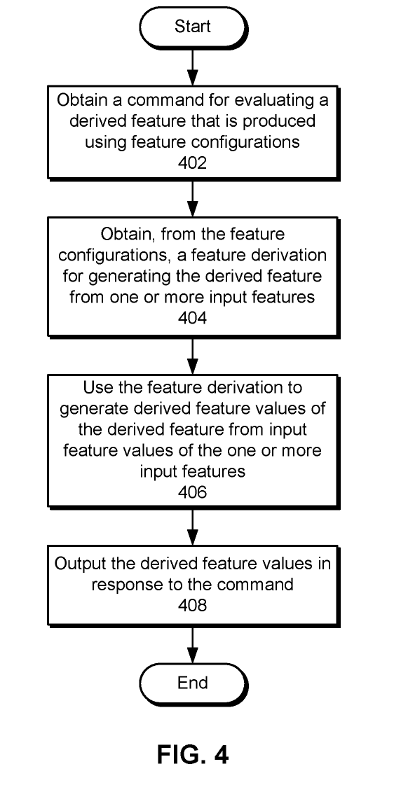

FIG. 4 shows a flowchart illustrating the processing of a command in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a command for evaluating a derived feature that is produced using feature configurations is obtained (operation 402). The command may be specified using a CLI, GUI, and/or other type of user interface. Next, a feature derivation for generating the derived feature from one or more input features is obtained from the feature configurations (operation 404). For example, the feature derivation may be identified by name or path in a parameter of the command, or the content of the feature derivation may be included in the parameter.

The feature derivation is then used to generate derived feature values of the derived feature from input feature values of the input feature(s) (operation 406). For example, an expression, operation, and/or reference to code for calculating the derived feature may be obtained from the feature derivation and applied to the input feature values to produce the derived feature values.

Finally, the derived feature values are outputted in response to the command (operation 408). For example, the derived feature values may be outputted in one or more records, along with optional input feature values used to produce the derived feature values. In turn, the outputted data may allow users to verify the feature derivation and/or identify and analyze errors associated with generating the derived feature using the feature derivation.

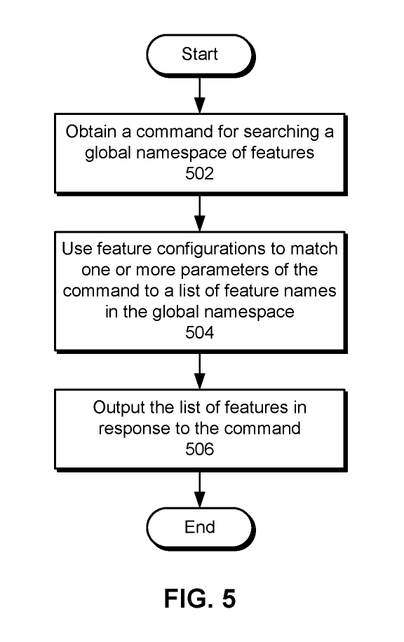

FIG. 5 shows a flowchart illustrating the processing of a command in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a command for searching a global namespace of features is obtained (operation 502). For example, the command may request a listing of all feature names in the global namespace and/or include a string, substring, and/or regular expression to be matched to a subset of feature names in the global namespace.

Next, feature configurations are used to match one or more parameters of the command to a list of feature names in the global namespace (operation 504). Continuing with the previous example, the feature configurations may be searched for all feature names in the global namespace and/or a subset of feature names that match the parameter(s). Finally, the list of features is outputted in response to the command (operation 506).

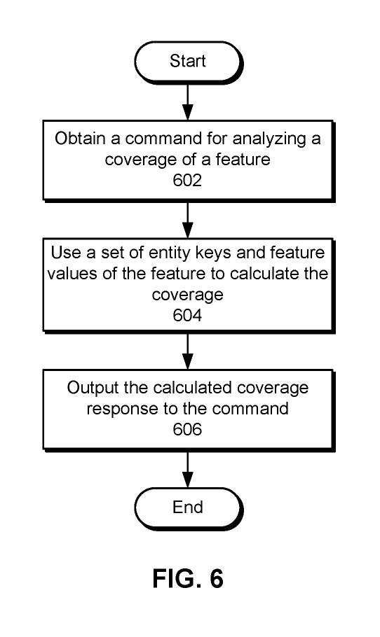

FIG. 6 shows a flowchart illustrating the processing of a command in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the technique.

Initially, a command for analyzing a coverage of a feature is obtained (operation 602). The command may include one or more parameters that identify the feature and/or one or more key tags associated with the feature. Next, a set of entity keys and feature values of the feature are used to calculate the coverage (operation 604). For example, all entity keys associated with the key tags may be retrieved, along with all feature values for the feature. The coverage may then be calculated as the percentage of entity keys for a given key tag that have feature values for the feature. Finally, the calculated coverage is outputted in response to the command (operation 606).

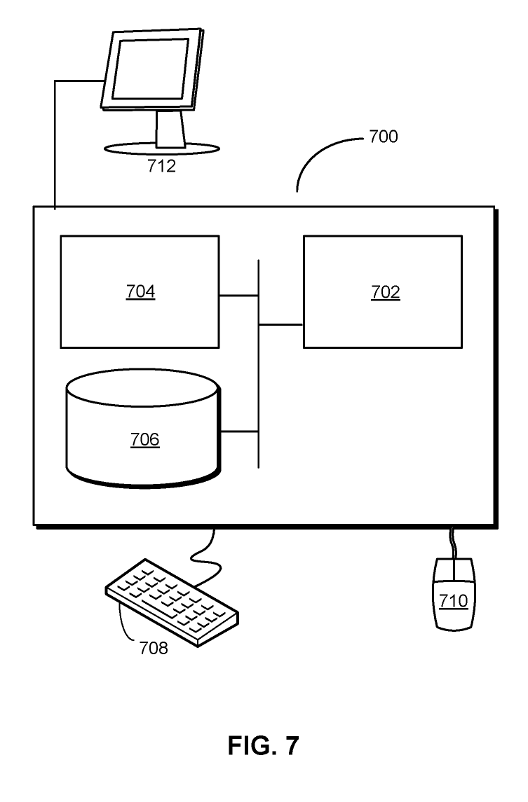

FIG. 7 shows a computer system 700. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for processing data. The system includes a set of service providers executing in multiple environments, one or more of which may alternatively be termed or implemented as a module, mechanism, or other type of system component. Each service provider may obtain feature configurations for a set of features and a command for inspecting a data set that is produced using the feature configurations. Next, the service provider may obtain, from the feature configurations, one or more anchors containing metadata for accessing the set of features in an environment and a join configuration for joining the feature with one or more additional features. The service provider may then use the anchor(s) to retrieve feature values of the features and zip the feature values according to the join configuration without matching entity keys associated with the feature values. Finally, the service provider may output the zipped feature values in response to the command.

In addition, one or more components of computer system 700 may be remotely located and connected to the other components over a network. Portions of the present embodiments (e.g., service providers, environments, feature consumers, feature management framework, etc.) may also be located on different nodes of a distributed system that implements the embodiments. For example, the present embodiments may be implemented using a cloud computing system that manages, defines, generates, retrieves, and/or provides feedback related to features in a set of remote environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining feature configurations for a set of features;
obtaining a command for inspecting a data set that is produced using the feature configurations;
obtaining, from the feature configurations:
one or more anchors comprising metadata for accessing the set of features in an environment; and
a join configuration for joining a feature with one or more additional features;
using the one or more anchors to retrieve, by a computer system, feature values of the feature and the one or more additional features;
zipping, by the computer system, the feature values according to the join configuration without matching entity keys associated with the feature values; and
outputting the zipped feature values in response to the command.

2. The method of claim 1, further comprising:
outputting, with the zipped feature values, additional values used to generate the feature values of the feature and the one or more additional features.

3. The method of claim 1, further comprising:
obtaining an additional command for evaluating a derived feature that is produced using the feature configurations;
obtaining, from the feature configurations, a feature derivation for generating the derived feature from one or more input features;
using the feature derivation to generate derived feature values of the derived feature from input feature values of the one or more input features; and
outputting the derived feature values in response to the additional command.

4. The method of claim 1, further comprising:
obtaining an additional command for searching a global namespace of the features;
using the feature configurations to match one or more parameters of the additional command to a list of feature names in the global namespace; and
outputting the list of feature names in response to the additional command.

5. The method of claim 1, further comprising:
obtaining an additional command for analyzing a coverage of the feature;
using a set of entity keys and the feature values to calculate the coverage of the feature; and
outputting the coverage of the feature in response to the additional command.

6. The method of claim 1, wherein zipping the feature values according to the join configuration comprises:
identifying, in the join configuration, two variants of a single feature; and
including, in the zipped feature values for the two variants, different subsets of the feature values for the single feature.

7. The method of claim 1, wherein using the one or more anchors to retrieve feature values of the feature and the one or more additional features comprises:
obtaining, from a parameter of the command, a time range associated with the feature values; and
retrieving the feature values of the feature and the one or more additional feature to fall within the time range.

8. The method of claim 1, wherein using the one or more anchors to retrieve feature values of the feature and the one or more additional features comprises:
obtaining, from one or more parameters of the command, feature names of the feature and the additional features;
matching the feature names to the one or more anchors; and
using attributes of the one or more anchors to retrieve the feature values from the environment.

9. The method of claim 1, wherein the feature configurations are obtained from a parameter in the command.

10. The method of claim 1, wherein the environment is at least one of:
an online environment;
a nearline environment;
an offline environment;
a stream-processing environment; and
a search-based environment.

11. The method of claim 1, wherein the command is received through a command-line interface.

12. A system, comprising:
one or more processors; and
memory storing instructions that, when executed by the one or more processors, cause the system to:
obtain feature configurations for a set of features;
obtain a command for inspecting a data set that is produced using the feature configurations;
obtain, from the feature configurations:
one or more anchors comprising metadata for accessing the set of features in an environment; and
a join configuration for joining a feature with one or more additional features;
use the one or more anchors to retrieve feature values of the feature and the one or more additional features;
zip the feature values according to the join configuration without matching entity keys associated with the feature values; and
output the zipped feature values in response to the command.

13. The system of claim 12, wherein the memory further stores instructions that, when executed by the one or more processors, cause the system to:
output, with the zipped feature values, additional values used to generate the feature values of the feature and the one or more additional features.

14. The system of claim 12, wherein the memory further stores instructions that, when executed by the one or more processors, cause the system to:
obtain an additional command for evaluating a derived feature that is produced using the feature configurations;
obtain, from the feature configurations, a feature derivation for generating the derived feature from one or more input features;
use the feature derivation to generate derived feature values of the derived feature from input feature values of the one or more input features; and
output the derived feature values in response to the additional command.

15. The system of claim 12, wherein the memory further stores instructions that, when executed by the one or more processors, cause the system to:
obtain an additional command for searching a global namespace of the features;
use the feature configurations to match one or more parameters of the additional command to a list of feature names in the global namespace; and
output the list of feature names in response to the additional command.

16. The system of claim 12, wherein the memory further stores instructions that, when executed by the one or more processors, cause the system to:
obtain an additional command for analyzing a coverage of the feature;
use a set of entity keys and the feature values to calculate the coverage of the feature; and
output the coverage of the feature in response to the additional command.

17. The system of claim 12, wherein zipping the feature values according to the join configuration comprises:
identifying, in the join configuration, two variants of a single feature; and
including, in the zipped feature values for the two variants, different subsets of the feature values for the single feature.

18. The system of claim 12, wherein using the one or more anchors to retrieve feature values of the feature and the one or more additional features comprises:
obtaining, from a parameter of the command, a time range associated with the feature values; and
retrieving the feature values of the feature and the one or more additional feature to fall within the time range.

19. A non-transitory computer-readable storage medium storing instructions that when executed by a computer cause the computer to perform a method, the method comprising:
obtaining feature configurations for a set of features;
obtaining a command for inspecting a data set that is produced using the feature configurations;
obtaining, from the feature configurations:
one or more anchors comprising metadata for accessing the set of features in an environment; and
a join configuration for joining the feature with one or more additional features;
using the one or more anchors to retrieve feature values of the feature and the one or more additional features;
zipping the feature values according to the join configuration without matching entity keys associated with the feature values; and
outputting the zipped feature values in response to the command.

20. The non-transitory computer-readable storage medium of claim 19, wherein zipping the feature values according to the join configuration comprises:
identifying, in the join configuration, two variants of a single feature; and
including, in the zipped feature values for the two variants, different subsets of the feature values for the single feature.
